(19) United States
(12) Patent Application Publication
(10) Pub. No.: US 2019/0010412 A1
(43) Pub. Date: Jan. 10, 2019

(54) A METHOD AND SYSTEM FOR REMOVING TAR

(71) Applicant: University of Newcastle, Callaghan (AU)

(72) Inventors: Behdad Moghtaderi, Callaghan (AU); Kapit Shah, Callaghan (AU)

(73) Assignee: University of Newcastle, Callaghan (AU)

(21) Appl. No.: 16/065,727

(22) PCT Filed: Dec. 23, 2016
(86) PCT No.: PCT/AU2016/051286

§ 371 Date: Jun. 22, 2018

(30) Foreign Application Priority Data
Dec. 23, 2015 (AU) 2015905382

(51) Int. Cl. C10K 3/02; C01B 3/58

(52) U.S. Cl. CPC C10K 3/023; C01B 3/58

(57) ABSTRACT

The present invention provides a method (1) and system for the removal of tar from a synthesis gas (10) using a chemical loop (23). A first reactor (20, 55) is fed with mineral particles and the synthesis gas. The mineral particles catalyse the tar in the synthesis gas to produce a mixture comprising hydrogen and a mineral carbonate. A second reactor (15, 70) is fed with oxygen and the mineral carbonate. The oxygen reacts with the mineral carbonate to produce a flue gas (25) comprising carbon dioxide and mineral particles, which are then separated and the mineral particles are recycled to the first reactor.

### FIELD OF THE INVENTION

The present invention relates to a method and system for removing tar and in particular relates to a mineral looping method and system for removing tar. The invention has been developed primarily for the removal of tar from a synthesis gas using a mineral based chemical looping process.

### BACKGROUND TO THE INVENTION

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Biomass, which is primarily composed of cellulose, hemicellulose and lignin, is a promising fuel resource. Biomass is available worldwide and its use is close to carbon neutral due to the biocycle of CO₂, in which CO₂ released after biomass combustion is re-absorbed via photosynthesis reactions. Biomass, as a potential feedstock for alternative gaseous and liquid fuels, has an important role in replacing fossil fuels on a global scale, with a critical factor to determining its applications its utilisation/conversion efficiency. One of the main applications for biomass utilisation is power generation, and it is expected that the primary global energy demand for biomass-derived electricity will grow strongly from 14% to 26% in 2030.

Gasification is considered one of the most promising bioenergy technologies for several reasons. One reason is that gasification can achieve higher thermal efficiencies, when integrated with combined cycle power plants, than conventional boiler systems. A second reason is that gasification has extremely lower NOx and SOx emissions due to the absence of nitrogen and excess oxygen. Despite such advantages, the technology is not being used at full commercial scale because of several problems, fuel gas (producer gas) cleaning being one of the major factors among them. Fuel gas cleaning is important as the fuel gas contains some impurities such as tar, particles and toxic gases including NH₃ and HCl. Among the impurities, tars are the most notorious, which include chemically polyaromatic hydrocarbons (PAHs). Under the gasification temperature, tar exists as gas, while it condenses under ambient conditions (or below its dew point temperature) and deposits in the downstream equipment, blocking narrow pipelines. This tar deposition causes unwanted shutdown and major heat recovery losses. Tar particles also cause blockage and abrasion problems when the producer gas is used in downstream applications, such as engines and turbines. Therefore, for downstream applications of producer gas, the concentration of impurities must be below the maximum acceptable range for each individual application. Consequently, the development of an efficient tar removal process is highly desirable for successful biomass gasifier operation. Attempts to eliminate tar include the development of different types of gasifiers, cold gas filtration, hot gas filtration and catalytic gas cleaning.

### SUMMARY OF THE INVENTION

Accordingly, a first aspect of the present invention provides a method for removing tar from a synthesis gas, comprising:

feeding the synthesis gas into a first reactor;

feeding mineral particles into the first reactor;

catalysing tar in the synthesis gas with the mineral particles to produce a mixture comprising hydrogen and a mineral carbonate;

feeding the mineral carbonate into a second reactor;

feeding oxygen into the second reactor to react with the mineral carbonate and produce a flue gas comprising carbon dioxide and mineral particles;

separating the carbon dioxide from the mineral particles; and

recycling the mineral particles to the first reactor.

Preferably, the method comprises reforming carbon from the mixture. More preferably, the carbon is reformed in the presence of steam. In one embodiment, the method comprises directing the mixture to a first chamber and feeding steam into the first chamber.

Preferably, the method comprises passing the mineral particles through a gas to reactivate the mineral particles. More preferably, the gas comprises steam. In one embodiment, the method comprises directing the mixture to a second chamber and feeding steam into the second chamber. In some embodiments, the reactivating step is performed before recycling the mineral particles to the first reactor.

Preferably, the method further comprises feeding a portion of the synthesis gas to a combustion unit for generating power to operate the second reactor. More preferably, the method comprises feeding the remaining synthesis gas into the first reactor.

Preferably, the method comprises connecting the first reactor to the second reactor to form a mineral-looping process.

Preferably, the mineral particles are depleted in the first reactor and regenerated in the second reactor. More preferably, the mineral particles are reduced in the first reactor and oxidised in the second reactor. Alternatively or additionally, the mineral particles are carbonated in the first reactor to form a mineral carbonate and the mineral carbonate is decomposed into the mineral particles in the second reactor. In one embodiment, the first reactor is a carbonator and the second reactor is a calciner.

Preferably, the method comprises gasifying a biomass to produce the synthesis gas.

A second aspect of the present invention provides a system for removing tar from a synthesis gas, comprising:

a first reactor for receiving the synthesis gas;

a first conduit for feeding a mineral particles into the first reactor, wherein tar in the synthesis gas is catalysed in the first reactor to produce a mixture comprising hydrogen and a oxygen depleted mineral compound;

a second reactor for receiving the mixture; and

a second conduit for feeding oxygen into the second reactor to regenerate the oxygen depleted mineral compound and produce a flue gas comprising carbon dioxide and the mineral particles;

wherein the mineral particles from the second reactor is recycled to the first reactor.

Preferably, the system comprises a gasifier for gasifying a biomass to produce the synthesis gas.

Preferably, the system further comprises a first chamber for reforming carbon from the mixture. More preferably, the first chamber has an inlet for receiving steam to reform the carbon from the mixture. In one embodiment, the first chamber comprises a steam reformer unit.

Preferably, the system further comprises a second chamber for reactivating the mineral particles. More preferably, the second chamber has an inlet for receiving steam to reactivate the mineral particles. In one embodiment, the second chamber comprises a polisher unit.

Preferably, the system further comprises a third conduit for feeding a portion of the synthesis gas to a combustion unit for generating power to operate the second reactor. More preferably, the system further comprises a fourth conduit for feeding the remaining synthesis gas into the first reactor.

Preferably, the first reactor is connected to the second reactor to form a mineral-looping process.

Preferably, the second conduit feeds air into the second reactor.

Preferably, the first reactor has an outlet for removing the hydrogen the hydrogen from separated from the mineral carbonate in the mixture.

Preferably, the second reactor has an outlet for removing the hydrogen the hydrogen from separated from the mineral carbonate in the mixture.

Preferably, the mixture further comprises carbon monoxide, carbon dioxide and water vapour.

Preferably, the mineral particles comprise a metal or a metal oxide that is suitable for a carbonation and/or oxidation reaction. More preferably, the mineral particles comprise a mineral carbonate. In some embodiments, the mineral particles are selected from the group consisting of: PbO; CaO; MgO; Na; K; ZnO; MnO; CoO; Li₂O; Sr; Fe; CuO; Mg olivine (Mg₂SiO₄); Mg serpentine (Mg₃Si₂O₅(OH)₄); wollastonite (CaSiO₃); basalt; bauxite; magnetite (Fe₃O₄); brucite (Mg(OH)₂); forsterite (Mg₂SiO₄); harzburgite (CaMgSi₂O₆); orthopyroxene (CaMgSi₂O₆); dunite (Mg₂SiO₃ with impurities); ilmenite (FeTiO₃); dolomite (CaMg(CO₃)₂) and combinations or mixtures thereof.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the drawings of which:

FIG. 1 is a schematic drawing of a method and system according to one embodiment of the invention;

FIG. 2 is a schematic drawing of another embodiment of the invention;

FIG. 3 is a schematic drawing of a fast internally circulating fluidised bed (FICFB) reactor for use with the invention;

FIGS. 4A and 4B are graphs showing the effect of compression ratio on the unit power production and gas turbine temperature under different air/fuel ratios, respectively;

FIGS. 5A and 5B are graphs showing the effect of carbonator temperature on unit power production and gas turbine inlet temperature, respectively;

FIG. 6 is a schematic drawing of shows the effect of carbonator temperature on syngas composition;

FIGS. 7A and 7B are graphs showing the effect of the ratio Ca/B on unit power production and gas turbine inlet temperature, respectively;

FIGS. 8A and 8B are graphs showing the effect of the ratio S/B on unit power production and gas turbine inlet temperature, respectively;

FIG. 9 is a graph showing the effect of calciner temperature on the unit power production of a biomass gasification plant with combined cycle;

FIG. 10 is a graph showing the FTIR gas evolution as a function of time for 1% O₂ gasification and a CaO:B ratio of 1;

FIG. 11 is a graph showing comparing the functional group peak areas for 1% O₂ gasification of biomass (CaO:B=0) and Biomass and CaO (CaO:B=1) at 350° C.;

FIG. 12 is a schematic drawing of a further embodiment of the invention;

FIG. 13 is a schematic drawing of yet another embodiment of the invention; and

FIG. 14 is a schematic drawing of a yet further embodiment of the invention.

### DETAILED DESCRIPTION OF PREFERRED EMBODIMENTS

The present invention will now be described with reference to the following examples which should be considered in all respects as illustrative and non-restrictive. In the Figures, corresponding features within the same embodiment or common to different embodiments have been given the same reference numerals.

Biomass gasification is a process in which carbonaceous fuels are converted into synthesis gas (or the well known term, syngas) via a thermochemical route. The produced syngas should ideally have a high lower heating value (LHV) in order to benefit the downstream energy/power conversion processes. The syngas quality, however, is affected by the use of different gasification agents. For instance, biomass gasification using air as the gasification agent only produces syngas with a low LHV of about 4.4 MJ/m³, while using pure oxygen, a much higher LHV (about 9.6 MJ/m³) can be achieved. Nevertheless, using pure oxygen as the gasification agent requires additional costs associated with an air separation unit (ASU). On the other hand, biomass gasification using steam as the gasification agent has also been considered as a way to improve hydrogen content in syngas.

Steam gasification in a dual fluidised bed gasifier is the most suitable for biomass in comparison to other gasifier types, such as fixed/moving bed and entrained flow, due to its scale and compatibility with many different fuels. Biomass steam gasification is an endothermic process in which a small amount of oxidant (e.g., pure oxygen, air and etc.) is required to combust a fraction of the char produced to provide the energy for the gasification reaction. Without N₂ dilution, the volatile matter and char can directly react with steam and generate higher HHV syngas. Dual fluidised bed steam gasification, therefore, is a promising technology to produce higher quality syngas which mainly consists of H₂ and CO.

Numerous modelling of biomass steam gasification in a dual fluidised bed for different purposes has been performed. It has been found that, for a 10 MW biomass gasification power plant integrated with a gas turbine, the gasification temperature and the oxygen content of the fuel significantly affected the gasification chemical efficiency and the net power efficiency achieved was 18%. It has also been found that a combined heat and power steam cycle system results in a 10% power efficiency when biomass gasification is combined with a steam turbine. It has further been found that a biomass integrated gasification combined cycle (BIGCC) for heat and power production at ethanol plants can generate process heat and significant amounts of electricity, with a power efficiency of about 24%. Where a corn ethanol plant is used the BIGCC results in a net power efficiency was in the range of 18% to 22%. However, the sensible heat loss during tar trapping, which exists in a real BIGCC process, was not considered as it greatly affects the net power efficiency. Moreover, the sensible heat loss is required to understand the influence of fuel and operating parameters on the performance of a plant in terms of the design and operation of a gasifier.

While the preferred embodiments will be described using biomass as the fuel source for the gasification of synthesis gas, it will be appreciated that the synthesis gas can be produced from the gasification of other fuel sources, such as coal, crude oil or methane. Similarly, the gasification of the biomass is not limited to the application of steam, but can include air or pure oxygen. However, for the reasons stated above, it preferred that steam is used for gasification of the biomass due to its advantages in improving the hydrogen content of the synthesis gas.

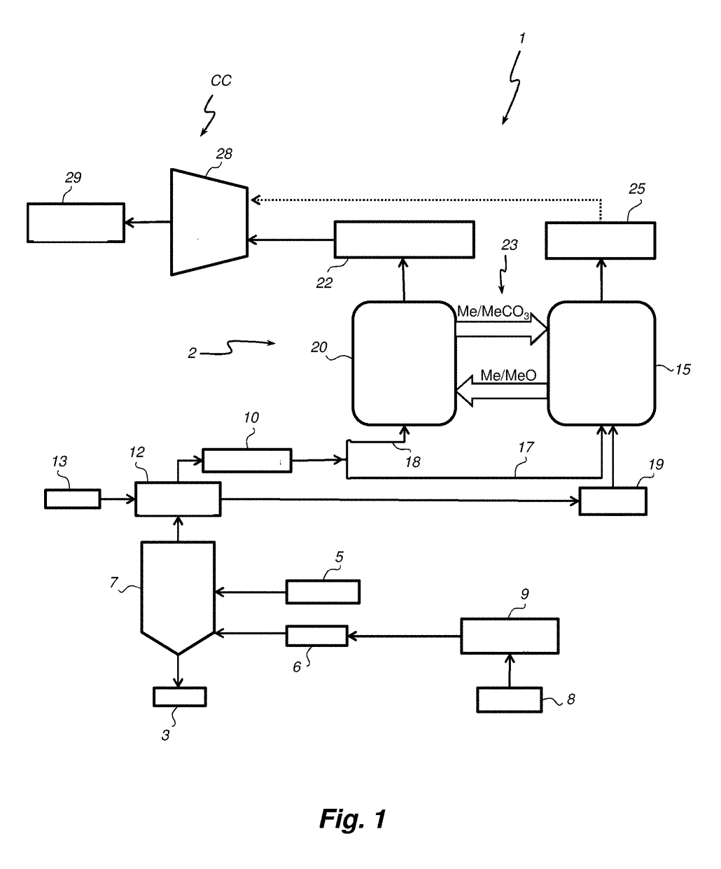

FIG. 1 shows a schematic drawing of a method 1 according to one embodiment of the invention, where a biomass integrated gasification combined cycle (BIGCC) is connected to a mineral-looping tar removal (MLTR) process 2 using calcium Ca as the mineral particle Me. As illustrated in FIG. 1, biomass 5 is gasified in the presence of steam 6 in a gasifier 7 where reactions R1-R6 as listed in Table 1 below take place as part of the biomass integrated gasification (BIG) process. Ash 3 is removed from the gasifier 7 while the steam 6 is generated from water 8 passing through a heat exchanger 9 from a water supply (not shown).

TABLE 1
Major chemical reactions in the MLTR process (Me═Ca)

| | ΔH_{923K}, | |
|---|---|---|
| Reactions | kJ/mol | Number |
| Steam reforming: C + H₂O ↔ H₂ + CO | +130 | (R1) |
| Boudouard reaction: C + CO₂ ↔ 2CO | +173 | (R2) |
| Methane reforming: C + 2H₂ ↔ CH₄ | −75 | (R3) |
| Water-gas shift reaction: CO + H₂O ↔ CO₂ + H₂ | −42 | (R4) |
| Steam methane reforming: CH₄ + H₂O ↔ CO + 3H₂ | +205 | (R5) |
| Dry methane reforming: CH₄ + CO₂ ↔ 2CO + 2H₂ | +248 | (R6) |
| Carbonation reaction: CaO + CO₂ ↔ CaCO₃ | −171 | (R7) |
| Gas cleaning reactions: | | |
| CaO + H₂S ↔ CaS + H₂O | −64 | (R8) |
| CaO + 2HCl ↔ CaCl₂ + H₂O | −217 | (R9) |
| Calcination reaction: CaCO₃ → CaO + CO₂ | +171 | (R10) |

The bio-syngas 10 produced then passes through a heat exchanger 12 to preheat the air 13 fed into a reactor. In this embodiment, the reactor is a regenerator 15. In other embodiments, the reactor may be a moving bed reactor, a fluidised bed reactor (bubbling or circulating bed), an oxidiser or a calciner. After the heat exchanger 12, the bio-syngas 10 is divided into two streams using conduits 17, 18. In one conduit 17, a small portion of the produced syngas (bio-syngas) is combusted with preheated hot air 19 to provide the required energy to operate the regenerator 15, while the other conduit 18 transfers the remaining (and greater) portion of the syngas 10 and feeds it into another reactor. In this embodiment, the reactor is a tar cracker unit 20. In other embodiments, the reactor may be a moving bed reactor, a fluidised bed reactor (bubbling or circulating bed), a carbonator or reducer. In the tar cracker unit 20, the LHV of syngas is improved via a series of primary chemical reactions; generally, carbon oxidation or reforming; combustion of synthesis gas; calcination of mineral particles; and oxidation of mineral particles. More specifically, they are reactions (R3), (R5), (R6) and (R7) from Table 1 above. More importantly, bio-tars are decomposed in the tar cracker unit 20 by catalysis using a mineral oxide, which in this embodiment is CaO, resulting in the formation of H₂ rich syngas 22, thereby increasing the overall LHV of syngas.

The regenerator 15 and tar cracker unit 20 are connected to form a calcium looping process, where the calcium based particles are transferred between the calciner and carbonator to regenerate the CaO particles for the tar cracking process. More specifically, the consumed CaO is converted into CaCO₃ in the tar cracker unit 20 as part of the tar removal process and the CaCO₃ is then transferred by the loop 23 to the regenerator 15, where the hot air 1 and the small portion of syngas reacts with the CaCO₃ to regenerate CaO that is then recycled back to the tar cracker unit 20.

Some corrosive gases such as H₂S and HCl in syngas will be adsorbed by the CaO in the tar cracker unit 20, which can greatly decrease the workload of later gas cleaning operations. An additional advantage over conventional BIGCC technology is that CO₂ in the flue gas 25 generated by the regenerator 15 can be greatly concentrated by the MLTR process 2. The removal of H₂S, HCl and the gas cleaning operations are not shown for the sake of clarity and because there are only trace amounts of corrosive gases produced. The hot H₂ rich syngas 22 after the tar cracker unit 20 is compressed and subsequently fed into a combined cycle CC, which in this embodiment comprises a gas turbine 28 to generate power. Exhaust gases 29 from the gas turbine 28 are released into the ambient environment. Alternatively, the combined cycle CC may also comprise a steam-driven turbine so that steam can be generated from the hot flue gas 25 eluted from the regenerator 15 can be used to generate power. In this alternative, the steam is fed directly into the steam turbine by mixing it with the hot exhaust gas 29 from the gas turbine 28.

Thus, the method 1 enables the syngas 10 to be “cleaned” by the MLTR process 2 by reducing or removing the tar present in the syngas prior to its subsequent downstream use, such as the combined cycle CC. In comparison with conventional BIGCC processes, the method 1 has the following advantages:
elimination of tar removal processes used in a conventional BIGCC plant, as tar can be decomposed in the presence of CaO.
elimination of problems associated with ash separation from CaO, as would occur in a conventional process with CaO recycling where biomass and CaO are present in the same reactor (carbonator).
avoiding energy and exergy losses of the hot syngas produced from biomass gasification, which would otherwise occur during the cold trap process in a conventional BIGCC plant for condensing tar from the hot syngas.
obtaining a syngas with an improved energy density for the better utilisation of syngas and a flue gas with concentrated CO₂ for more efficient CO₂ capture/sequestration.

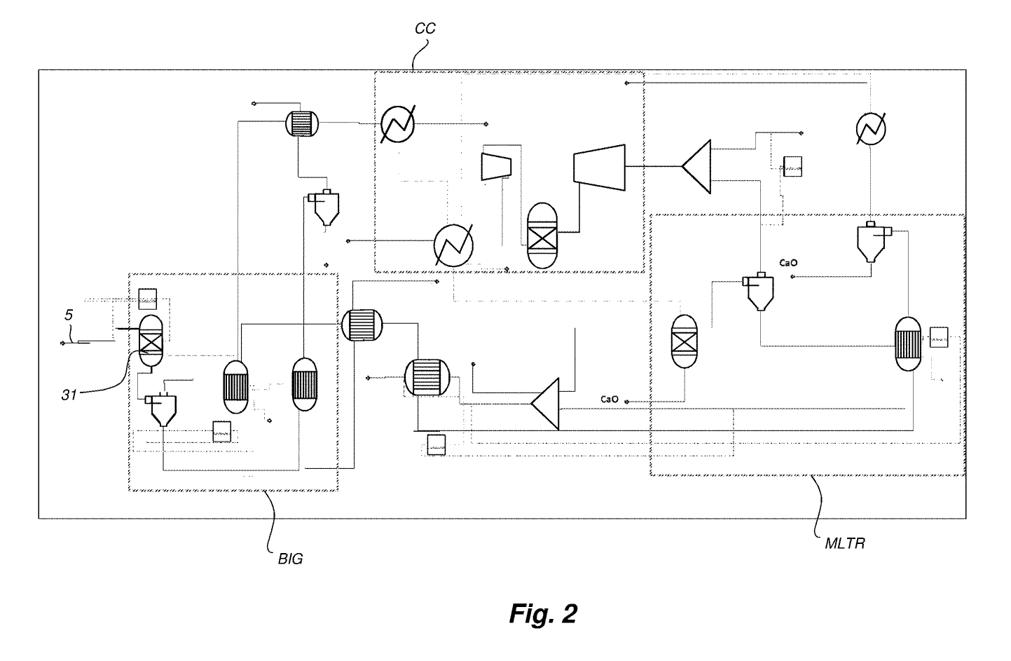

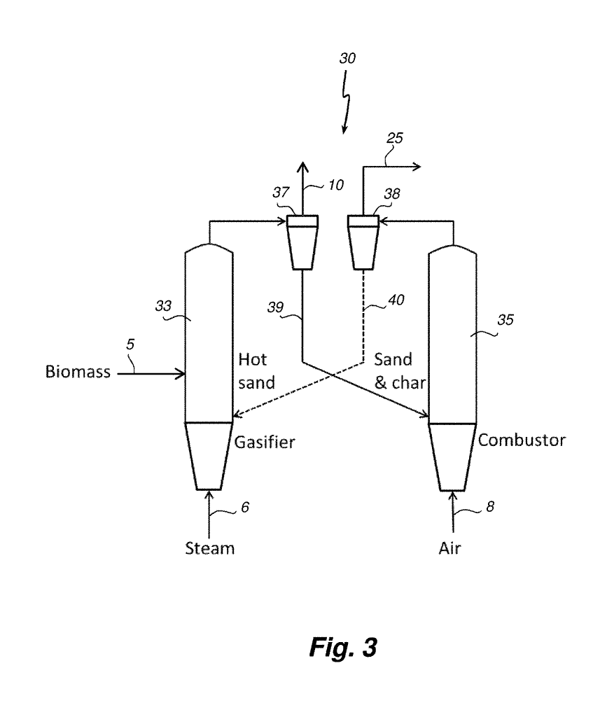

Another embodiment of the invention is illustrated in FIGS. 2 and 3, involving indirect calcium looping process and a fast internally circulating fluidised bed (FICFB) gasifier 30. The main BIG, CC and MLTR processes are indicated by FIG. 2. As shown in FIG. 2, biomass 5 is first decomposed into its elemental components C, H, O, N, S and CI using an R-yield reactor 31, and is then fed into the gasifier 30 comprising two reaction zones 33, 35.

The characteristics of the biomass 5 used in the embodiment is summarised in Table 2 below.

TABLE 2
Fuel properties of the biomass feedstock

| | wt. % | Ultimate | wt. % |
|---|---|---|---|
| Proximate analysis | (db) | analysis | (db) |
| Moisture | 20 | C | 51.19 |
| fixed carbon | 18.84 | H | 6.08 |
| volatile matter | 80 | O (by | 41.3 |
| | | difference) | |
| Ash | 1.16 | N | 0.2 |
| lower heating value (LHV) | MJ/kg | total sulphur | 0.02 |
| | 19.09 | Chlorine | 0.05 |

As shown in FIG. 3, the FICFB gasifier 30 comprises two separate reaction zones; one reaction zone 33 being gasification of biomass 5 and the other reaction zone 35 being combustion. The gasification and combustion zones 33, 35 are distinct areas within the one reactor. The FICFB reactor has a dual circulating fluidised bed reactor design.

In this embodiment, 15 wt. % of the carbon content (char) in biomass leaves the gasification zone 33 via separator 37. In the combustion zone 35, the embodiment handles the mass and energy balance for complete combustion assuming an air to fuel ratio of 1.12:1. The flue gas 25 produced in the combustion zone 35 is used to preheat the water into steam for gasification using a heat exchanger 38 and is subsequently fed into the combined cycle system 3 in the form of a steam turbine. Also, energy released during combustion of char will be used to preheat the sand. A conduit 39 directs the sand and char into the combustion zone 35 while conduit 40 returns hot sand back to the gasification zone 33.

In other embodiments, the FICB reactor 30 is replaced by two separate reactors embodying the reaction zones 33, 35. That is, in one reactor the biomass 5 is subject to gasification while combustion occurs in the other reactor. Gasification is generally endothermic reaction and requires additional energy input. In standard bubbling bed or entrained flow reactors this energy input is provided by partial combustion by providing air or oxygen into the reactor. However, such air dilution may reduce the energy density of the synthesis gas and using pure oxygen may be extremely expensive. Therefore, for these reasons it is preferred to use a dual circulating fluidised bed where gasification and combustion reactions are separated.

The initial operating conditions for the MLTR process for the embodiments of FIGS. 2 and 3 are set out Table 3 below.

TABLE 3
Summary of the initial operating conditions
used in the MLTR process

| | | | |
|---|---|---|---|
| Temperatures | Gasifier: gasification zone | 800° | C. |
| | Gasifier: combustion zone | 870° | C. |
| | Inlet steam of the gasifier | 300° | C. |
| | Inlet air of the gasifier | 300° | C. |
| | Carbonator | 650° | C. |
| | CaO entering the Carbonator | 800° | C. |
| | Calciner | 800° | C. |
| | Inlet air of the calciner | 300° | C. |
| | CaO entering the Calciner | 650° | C. |
| | Air mixed with syngas | 20° | C. |
| | Exhaust gas of the combined cycle | 120° | C. |
| | Biomass, combustion air and water | 20° | C. |
| | for steam production | | |
| Pressures | Biomass, combustion air and water | 1 | bar |
| | for steam production | | |
| | Exhaust gas into atmosphere | 1 | bar |
| | Gasifier, carbonator and calciner | 1 | bar |
| | Gas turbine inlet pressure | 10 | bar |

| | | |
|---|---|---|
| Efficiencies | Gas turbine/isentropic | 0.8[16] |
| | Gas turbine/mechanical | 0.98[16] |
| Air to fuel ratio | Gasifier/combustion zone | 1.12[14] |
| Gas agent to fuel | Gasifier/gasification zone | 0.17 kg/kg[16] |
| ratio^{a} (λ) | | |

^{a}The gas agent to fuel ratio was considered according to the design of a 10 MW thermal power station in Austria.

The MLTR process was modelled using the following assumptions:
(1) All reactors were operated under stable conditions, and there was sufficient residence time to achieve chemical and phase equilibrium for all reactions.
(2) All reactors were operated in auto-thermal mode by either recovering/extracting excess heat using a water stream or combusting biomass/syngas to meet heat demands.
(3) The elements N, S and CI were converted into NH₃, H₂S, COS and Cl₂, respectively. Due to the trace amount of these elements, their influence on CaO was neglected during simulation.
(4) Char was assumed to be pure carbon.
(5) No tar removal process was required as tar was assumed to undergo complete decomposition into light hydrocarbon gases in the presence of CaO, which were subsequently converted into H₂, CO, CH₄ and CO₂.
(6) The O₂ concentration in the flue gases of the gasifier and calciner were always 3% in excess to ensure complete combustion of char/syngas.
(7) The recovery of the sensible heat of the exhaust gases for hot water production and district heating was not considered as the primary focus of this study was power generation efficiency.

In the embodiment, the effects of various parameters including the compression ratio of the gas turbine, air/fuel ratio entering the gas turbine, mass ratios of CaO to biomass (Ca/B), steam to biomass (S/B), and temperatures of the carbonator and calciner (T) on the thermodynamic performance of the CL-BIGCC process were assessed. The ratios Ca/B and S/B were defined as follows:

$$\begin{matrix}Ca / B = \frac{{M}_{Ca O}}{{M}_{Biomass}} & ( 1 ) \\ S / B = \frac{{M}_{Steam}}{{M}_{Biomass}} & ( 2 )\end{matrix}$$

where
M_{CaO} is the circulated mass flow rate of CaO added into fuel reactor;
M_{Biomass} is the mass flow rate of biomass added into gasifier; and
Mₛₜₑₐₘ is the circulated mass flow rate of steam.

In addition, the compression ratio (Rₚ) is defined as:

$${R}_{p} = {( \frac{{P}_{2}}{{P}_{1}} )}^{0.71} \qquad ( 3 )$$

where
P₁ is the pressure before the compressor; and
P₂ is the pressure after the compressor.

The gross power efficiency (η) and net power efficiency (φ) of the whole process was calculated by Equations (4) and (5), as set out below. In some instances it is more important to calculate the unit power production per kg of biomass, and this quantity can be calculated by Equation (6), as set out below.

$$\begin{matrix}η = \frac{{E}_{g} + {E}_{s}}{{m}_{B} * {LHV}_{B} * 0.278} \times 100 \% & ( 4 ) \\ ϕ = \frac{{E}_{g} + {E}_{s} - {E}_{c}}{{m}_{B} * {LHV}_{B} * 0.278} \times 100 \% & ( 5 ) \\ Unit power production = ( {E}_{g} + {E}_{s} - {E}_{c} ) / {m}_{B} & ( 6 )\end{matrix}$$

where
E_{g} is the power generated by the gas turbine (kW);
Eₛ is the power generated by the steam turbine (kW);
E_{c} is the power consumed by the compressor (kW);
LHV_{B} is the lower heating value of biomass (MJ/hr); and
m_{B} is the mass flow rate of biomass (kg/hr) fed into the gasifier.

A series of preliminary biomass gasification (i.e. partial oxidation in 1% O₂) experiments with and without CaO were completed to demonstrate the tar cracking ability of the carbonator in the MLTR process. A thermo-gravimetric analyser coupled with a Fourier Transform Infrared Spectrometer (TGA-FTIR) was used to allow for online mass loss and gas evolution characterisation.

Due to its abundant availability in Australia, radiata pine (75-150 μm particle size) was the biomass sample used in all experiments, with its proximate analysis presented in Table 4. Omya limestone was the source of CaO of which the XRF analysis is presented in Table 5.

TABLE 4
Proximate analysis of radiata pine on dry basis

| M | V | FC | Ash |
|---|---|---|---|
| (%) | (% d.b.) | (% d.b.) | (% d.b.) |
| 7.9 | 87.0 | 12.9 | 0.1 |

TABLE 5
XRF Analysis of Omya limestone

| Ca | Fe | Mg | Al | Si | Mn | K |
|---|---|---|---|---|---|---|
| 97.56 | 0.23 | 0.38 | 0.15 | 1.21 | 0.43 | 0.04 |

TGA conditions for all experiments consisted of 5 mg biomass sample, 100 mL/min flow rate of 1% O₂ in nitrogen, heating rate of 10° C./min and final gasification temperature of 800° C. FTIR scans were taken at 10° C. intervals and operating conditions consisted of a gas cell length of 10 cm and temperature of 240° C., transfer line temperature of 240° C., 32 scans per spectra for a scan range of 500-4000 cm⁻¹ and resolution of 4 cm⁻¹. Experimental scenarios examined were biomass gasification in 1% O₂, and a 1:1 mass ratio of CaO to biomass gasification in 1% O₂.

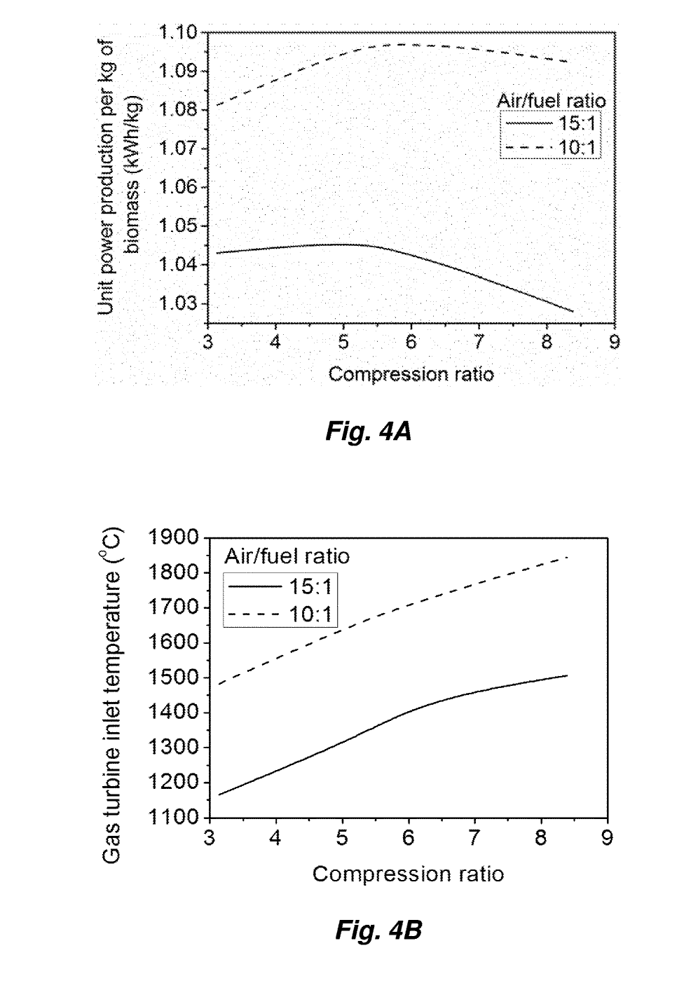

FIG. 4 shows the effect of the compression ratio of the gas turbine on the unit power production of a BIGCC plant using the MLTR process and the corresponding gas turbine inlet temperature under a hydrogen-rich syngas environment. FIG. 4B shows that for an air/fuel ratio of 15:1, the unit power generation first increases then decreases gradually as the compression ratio increases, achieving a maximum (1.046 kWh/kg biomass) at a compression ratio of about 5.8. The same trend was observed for a lower air/fuel ratio of 10:1. These trends indicate the complex interplay between the effects of compression ratio and syngas composition on the gross power production and auxiliary power consumption of the gas turbine unit. It was found that a low compression ratio is not beneficial in the case of using a hydrogen-enriched syngas due to the decreased power generation potential in the gas turbine. Neither is a high compression ratio beneficial to the net power generation because of the greatly increased power consumption of the gas compression process. Moreover, an increased air/fuel ratio from 10 to 15 was found to reduce the unit power production mainly because, for a given compression ratio, an increased air flow tends to reduce the operating temperature of the gas turbine, hence reducing the turbine efficiency significantly.

FIG. 4B presents the corresponding gas turbine inlet temperature variation as the compression ratio increases. It shows that the gas turbine inlet temperature increases as the compression ratio increases and decreases as the air/fuel ratio increases. This is because more inlet air tends to cool down the turbine further whilst a greater compression ratio increases the turbine inlet gas pressure and temperatures. Despite that, a greater gas inlet temperature leads to a greater efficiency of the gas turbine, with its operation largely limited by the upper operating limits of the materials used to fabricate the turbine. The air/fuel ratio thus plays a crucial role in the operation of a gas turbine and ensuring that the actual operating temperature is kept below the maximum allowable value. This frequently requires a great amount of excess air to reduce the operating temperature and leads to a high oxygen content (˜15%) in the turbine exhaust stream for a conventional natural gas-fired gas turbine. The air/fuel ratio and the oxygen content in the exhaust may be quite different if the syngas (especially a hydrogen-enriched syngas) is to be used in a gas turbine. Indeed, the results in FIG. 4B show that a low air/fuel ratio of 15, instead of 60-200 as used in a natural gas-fired gas turbine, gives a favourable gas turbine inlet temperature and is more appropriate for the BIGCC/MLTR process. The selection of an air/fuel ratio at 15 as the favoured ratio is also based on the consideration that the hydrogen-enriched syngas contains a large quantity of H₂O (˜40 vol. %) derived from biomass gasification. This greatly increases the unit fuel mass and thus greatly reduces the air/fuel ratio (note that without H₂O the air/fuel ratio can increase significantly considering the stoichiometric ratio of air/pure H₂ is ˜35). It can thus be concluded that a compression ratio of 5.1 and an air/fuel ratio of 15 are the most suitable operational conditions for the gas turbine in the BIGCC/MLTR process.

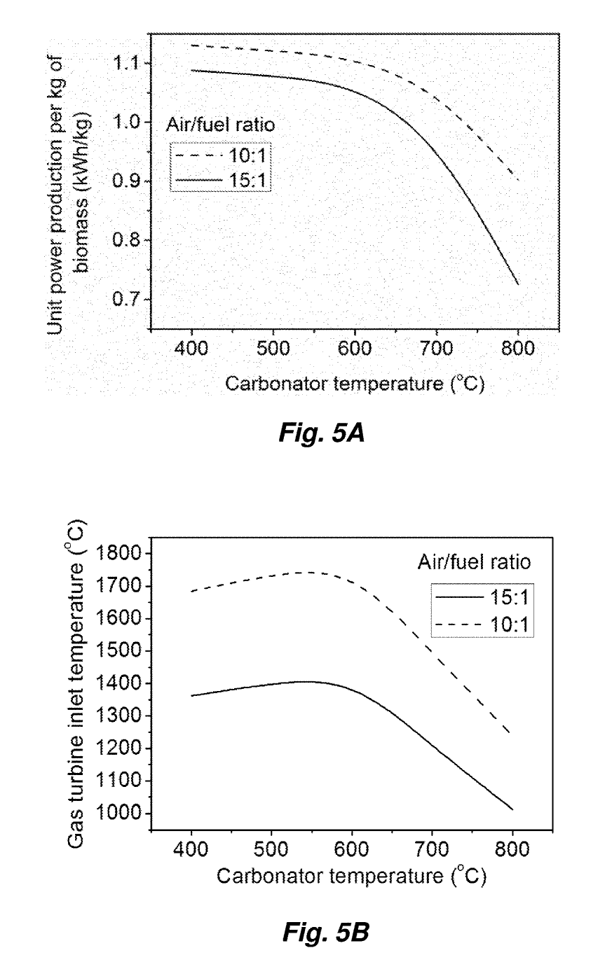

FIGS. 5A and 5B is a graph showing the effect of carbonator temperature on the unit power production of the plant while still monitoring the gas turbine inlet temperature. FIG. 5A shows that with a fixed air/fuel ratio of 10, the unit power production of the plant decreases from 1.13 kWh/kg of biomass to 0.90 kWh/kg of biomass or by 20% as carbonator temperature increases from 400° C. to 800° C. This is because at a greater carbonation temperature both the water-gas shift reaction and carbonation reaction are inhibited, resulting in less CO₂ capture and thus a greater amount of CO₂ in the syngas. This increased amount of CO₂ when entering into the compressor section of the gas turbine would greatly increase the compressor duty, yet it appears to contribute little to the power generation process. The net impact is therefore reduced net power production. On the other hand, a lower air/fuel ratio tends to increase the plant unit power production, again due to the increased gas turbine inlet temperature at a reduced air flow.

Similar to our previous results, FIG. 5B shows that with a varied carbonator temperature a lower air/fuel ratio at 10 was found to lead to greater power production but with unacceptable gas turbine inlet temperatures. Conversely, an air/fuel ratio of 15 is much more appropriate, leading to gas turbine inlet temperatures well below 1400° C. From the above analyses, the optimal carbonator temperature, from a pure thermodynamic point of view, was found to be 550° C. to ensure maximum plant efficiency. Nevertheless, this value was modified following the identification of suitable operating temperatures to achieve reasonably fast kinetics for the carbonation and tar cracking reactions in the MLTR process. This temperature was found to be 600-700° C. for a direct calcium looping process where both biomass/coal and CaO are fed into a single reactor for both carbonation and gasification reactions. After balancing the optimum plant efficiency, the allowable gas turbine inlet temperature, and the kinetics of the carbonation and tar cracking reactions, a carbonator temperature of 650° C. and an air/fuel ratio of 15 were identified to be the most favourable operating conditions for the BIGCC/MLTR process.

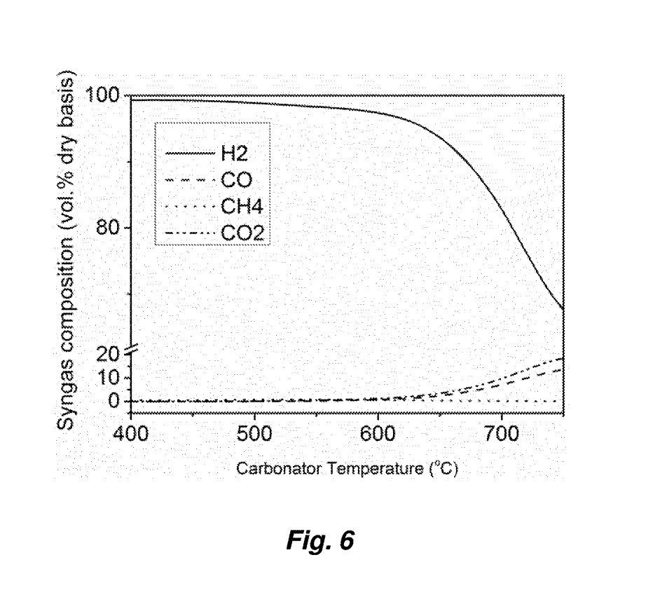

FIG. 6 is a graph showing the syngas composition as a function of carbonator temperature. As the carbonator temperature increases from 400° C. to 750° C. the concentration of H₂ in the produced syngas was found to first mildly decrease then drastically decrease to about 67%, whilst the concentrations of both CO and CO₂ significantly increase by about 15% and 20%, respectively. This is mainly due to the exothermal reactions of both the WGS reaction R(3) and the carbonation reaction R(10), which are inhibited at higher temperatures. Moreover, CH₄ can be greatly converted into H₂ via the methane steam reforming reaction R(5) and methane dry reforming reaction R(6) at high temperatures. It can also be seen in FIG. 6 that at the preferred carbonator temperature of 650° C. the produced syngas was found to contain a high concentration of H₂ at ˜92 vol % (dry basis).

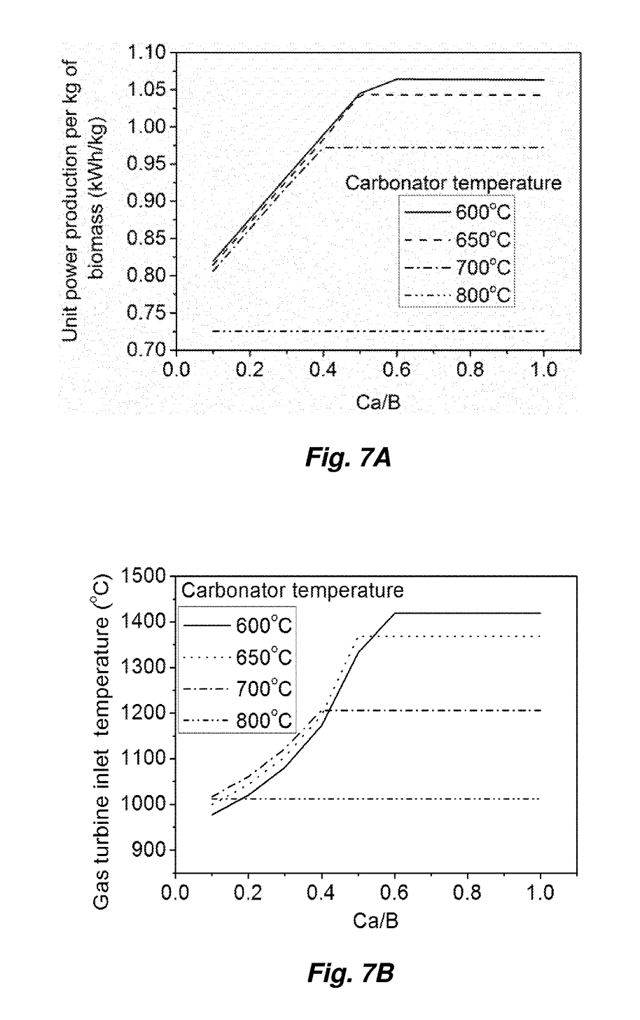

FIGS. 7A and 7B are graphs illustrating the effect of the Ca/B ratio on the unit power production of the process while monitoring the gas turbine inlet temperature. It can be seen in FIG. 7A that for carbonator temperatures below 800° C. the unit power production first increased linearly then plateaued as Ca/B ratio increased. This indicates that there is a maximum Ca/B ratio, at different carbonator temperatures, that allows for maximum possible CO₂ capture, and this ratio was found to decrease with increasing carbonator temperature. The reason behind this is a change to the chemical equilibrium of the carbonation reaction which was shifted to less CO₂ capture/conversion as the carbonation temperature increased. For instance, when the carbonation temperature increased to 800° C., no CO₂ capture occurred and thus the Ca/B ratio was found to have no effect on the plant power production (see the flat line in FIG. 7A). On the other hand, when an increasing amount of the CO₂ in the syngas was captured as a result of increasing CaO content and/or decreasing carbonator temperature, the syngas tended to contain more H₂ which increased the LHV of the syngas. A reduction in the CO₂ volume and an increase of LHV of the syngas were found to be advantageous for the syngas-fired gas turbine leading to increased net power production. At the predetermined carbonator temperature of 650° C. the unit power production was found to reach a maximum of 1.04 kW per kg of biomass when the Ca/B mass ratio reached 0.53. Under this carbonator temperature, the gas turbine inlet temperatures were always below 1400° C. which is within the allowable operating temperature range of a gas turbine, as best shown in FIG. 7B. Therefore, at a fixed carbonator temperature of 650° C. and a fixed air/fuel ratio of 15, a Ca/B ratio of 0.53 is just sufficient to achieve the optimal power production at the lowest CaO inventory cost.

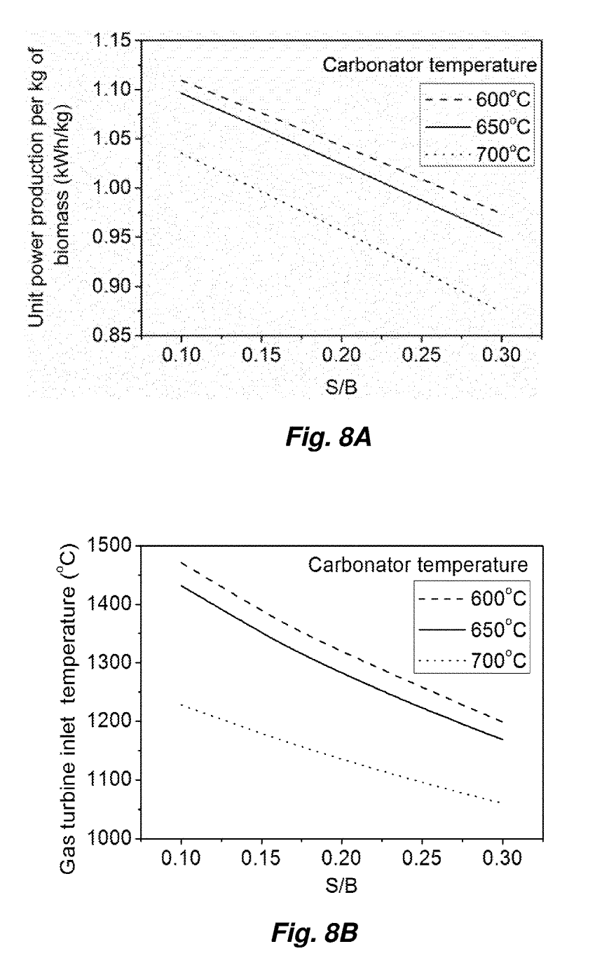

FIGS. 8A and 8B are graphs illustrating the effect of the S/B ratio on unit power production (FIG. 8A) and gas turbine inlet temperature (FIG. 8B) for three different carbonator temperatures. As can be seen in FIG. 8A, the unit power production dropped significantly with increasing S/B ratio and elevating temperature. It was found that increasing steam concentration promoted chemical reactions such as the steam reforming reaction, water-gas shift reaction and steam methane reforming reaction during biomass gasification. This typically leads to an increase in the H₂ concentration in the product gas. However, the increase in steam usage has a more profoundly negative effect on the unit power production, mainly owing to the significant increase in energy required to produce the steam as well as heat it to the required temperature. Nevertheless, a closer look at the gas turbine inlet temperature in FIG. 8B shows that an increasing steam flow effectively reduces the gas turbine inlet temperature, which may become a potential technique during practical operation to curb gas turbine inlet temperatures below its allowable limit.

With the above analysis in mind, the optimum S/B ratio should also consideration of the minimum required steam flow for fluidising the bed in the gasifier 30. When using steam as the gas agent, a good S/B ratio for both fluidisation and biomass gasification is 0.17. An S/B ratio of below 0.17, despite greater power production, may lead to poor fluidisation in addition to an elevated gas turbine inlet temperature which could damage the gas turbine blades (the gas turbine inlet temperature at an S/B mass ratio of 0.17 reaches 1322° C. as shown in FIG. 8B). By considering both the unit power production and gas turbine inlet temperature, the inventors considered that the S/B ratio should remain at 0.17 as the favourable S/B ratio for the BIGCC plant using the MLTR process.

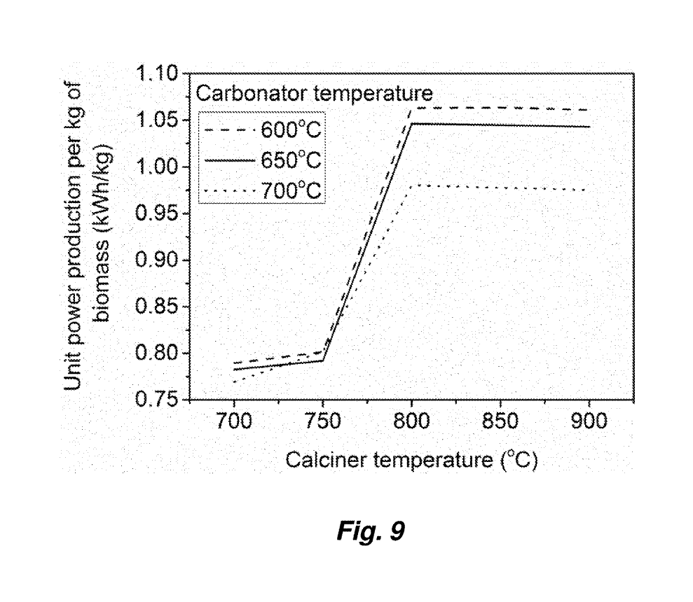

FIG. 9 is a graph illustrating the unit power production of the BIGCC plant using the MLTR process as a function of calciner and carbonator temperatures. It can be seen that as the calciner temperature increased from 750° C. to 800° C. the unit power production increased sharply to a maximum then slightly declined as the calciner temperature increased further. Also, it shows that a calciner temperature below 750° C. resulted in very low power generation as below this temperature the decomposition of CaCO₃ was found to be impossible. In addition, a calciner temperature between 750° C. and 800° C. does not enable full decomposition of CaCO₃. The consequence of which is a lesser amount of syngas being split from the raw syngas stream to the calciner in order to provide the reaction heat for the decomposition reaction. Thus, as a result of a reduced amount of available CaO in the carbonator, a greater CO₂ concentration will present in the syngas entering into the gas turbine. As discussed above, a greater CO₂ concentration in the gas turbine will reduce the power production, which matches well with the results in FIG. 9. In addition, a calciner temperature above 800° C. was found to be unnecessary due to the increased heating requirement along with increased exergy losses associated with waste heat recycling. This therefore suggests that the calciner temperature should be kept at 800° C. for the BIGCC/MLTR process to allow for maximum performance. On the other hand, as mentioned previously, for a given calciner temperature the unit power generation increased as the carbonator temperature decreased from 700° C. to 600° C. (see FIG. 5A).

The previous parametric analyses have identified the most suitable operating conditions of the BIGCC/MLTR process, including the compression ratio, air/fuel mass ratio, Ca/B mass ratio, S/B mass ratio, carbonator and calciner temperatures. With these operating conditions, the performance of the CL-BIGCC plant was obtained and the results are summarized in Table 6 and Table 7. Table 6 compares the syngas flows before and after the carbonator. As Table 6 shows, the mass flow rates of the syngas before and after the carbonator are 7633 and 2757 kg/hr, respectively (i.e. a reduction of 64%), while the LHV of the syngas was found to increase by 2.7 times from 34.43 MJ/kg to 92.21 MJ/kg. This indicates that the integrated calcium looping process functions well in a BIGCC process and significantly improved the syngas quality. The H₂ concentration was found to increase from 64 vol % to 94 vol % on a dry basis. The higher concentration of H₂ in the syngas is believed to contribute to a more efficient power generation process as evidenced in the parametric analyses. Moreover, it enables the CL-BIGCC process to employ a compact gas turbine design which has a much smaller size and thus a much lower cost compared to the conventional process.

TABLE 6
Comparison of product gas composition for FICFB
gasification with and without CO₂ capture

| Component | Unit | Before CO₂ capture | After CO₂ capture |
|---|---|---|---|
| H₂O | v-% | 41.5 | 40.8 |
| CH₄ | v-% (dry) | 0.01 | 0.33 |
| CO | v-% (dry) | 16.27 | 2.2 |
| CO₂ | v-% (dry) | 19.60 | 3.33 |
| H₂ | v-% (dry) | 63.93 | 93.91 |
| Mass flow | kg/hr | 7633 | 2757 |
| Density | kg/m³ | 0.23 | 0.12 |
| LHV | MJ/kg | 34.43 | 92.21 |

Table 7 below lists the calculated overall plant performance of the BIGCC/MLTR process and shows that the net power generation efficiency can reach 25%. With such efficiency, a BIGCC plant with a net power production of 47.5 MW would require a biomass consumption rate of 45,455 kg/hr, a steam flow of 7,727 kg/hr, and a CaO inventory of 22,727 kg/hr. The oxygen content in the flue gas of the gas turbine is 10%. Table 8 also compares the efficiency of the invention with other similar technology platforms using biomass gasification. It can be seen in Table 8 that the power generation efficiency of the BIGCC plant at 25% is among the highest of the parallel biomass steam gasification power generation processes.

TABLE 7
Performance results for a 47.5 MW BIGCC plant with MLTR

| Key parameters list | Results | Unit |
|---|---|---|
| Fuel-ᵢₙ(biomass) | 45 454.5 | kg/hr |
| CaO inventory | 22 727 | kg/hr |
| Q-ᵢₙ | 192.8 | MW |
| Steam-ᵢₙ flow rate | 7 727.2 | kg/hr |
| Cold flue 1 | 53 896.6 | kg/hr |
| Cold flue 2 | 285 058.0 | kg/hr |
| Cold flue 3 | 70 125.5 | kg/hr |
| Air/fuel ratio | 15 | kg/kg |
| Pressure rise over compressor | 9 | bar |
| Gas turbine inlet temperature | 1 301 | ° C. |
| Oxygen content of gas turbine exhaust | 10% | |
| Gross power generation * | 94.0 | MW |
| Power parasitic load | 46.5 | MW |
| Net power generation | 47.5 | MW |
| Net power generation efficiency | 25% | |

* Gross power generation includes power generated by a steam turbine and gas turbine with the steam cycle efficiency taken as 37%.

TABLE 8
Comparison of BIGCC/MLTR process with other conventional
biomass steam gasification power generation processes

| Power station | Net power generation | |
|---|---|---|
| scale | efficiency ^{b} | Comments |
| 9.6 MW | 10% | With steam turbine only [38] ^{a} |
| 10 MW | 18% | With gas turbine only [16] |
| 10 MW | 20%* | Combined BIGCC and ethanol |
| | | synthesis processes [21] |
| 50 MW | 25% | CL-BIGCC |

^{a} Considering combined heat and power application.
^{b} All figures in this table are based on the LHV of the fuel.
*Ethanol synthesis process is also factored in.

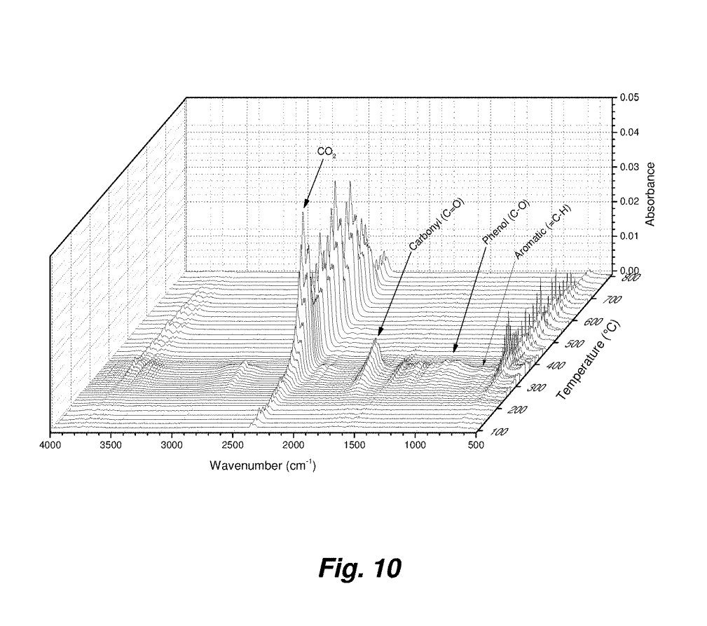

The tar cracking capabilities of CaO were also assessed using preliminary gasification (i.e. 1% O₂) experiments were conducted via a coupled TGA-FTIR apparatus. The FTIR volatile evolution profile for a CaO:B ratio of 1 is presented in FIG. 10. The primary volatile constituents observed were CO₂ (˜2400 cm⁻¹), as well as tar functional group constituents; carbonyl C═O (˜1600 cm⁻¹), phenol C—O (˜1100 cm⁻¹) and aromatic=C—H (˜800 cm⁻¹). Other volatiles observed included CO (˜2100 cm⁻¹), CH₄ (˜2900 cm⁻¹) and H₂O (˜3700 cm⁻¹).

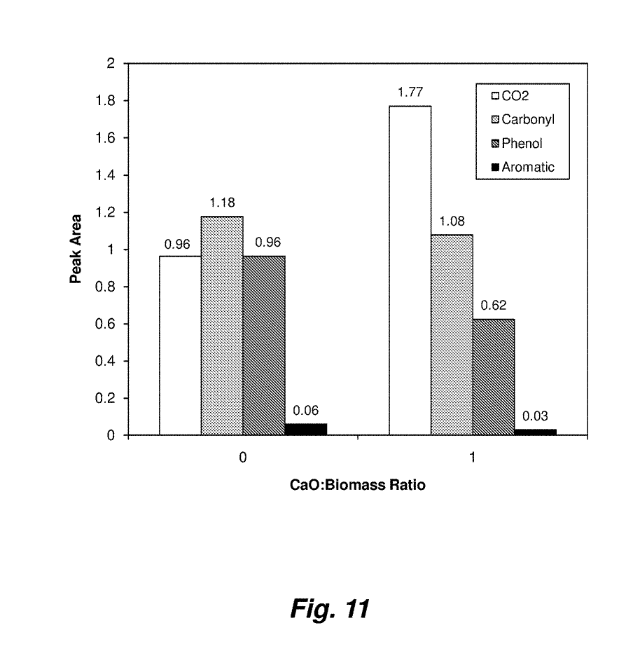

To gain a qualitative understanding of the tar cracking ability of CaO, the area under the curve of the carbonyl, phenol and aromatic peaks were taken when each peak reached its maximum at 350° C. The area under the CO₂ peak at 350° C. was also taken for comparison between treatments. The area under the curve for each of the aforementioned peaks is presented in FIG. 11 for biomass gasification (CaO:Biomass=0) and 1 to 1 gasification of CaO and biomass (CaO:Biomass=1). It can be seen in FIG. 11 that the area under the curve for each of the three functional groups decreased with the addition of CaO to the gasification process. Carbonyl group evolution reduced by 8.5%, phenol group evolution by 35% and the aromatic peak by 52%. The opposite trend was observed for the CO₂ peak area, with a significant increase (˜84%) observed when CaO was introduced to the gasification process. This increase was directly attributed to the cracking of tars and light hydrocarbons by CaO to form lower molecular weight species such as CO₂, CO and CH₄.

From this discussion, it can be observed that the MLTR process can avoid separation of ash from CaO particles and improve the LHV of syngas through chemical reactions in the presence of CaO and clean the syngas by simultaneous removing H₂S and HCl and inherently reduce the workload of the downstream gas cleaning unit. Moreover, it can produce syngas with a higher energy density. The MLTR process overcomes the problems of improving ash separation in a BIGCC process by separating the gasification and calcium looping operations allowing the CaO to be recycled and sensible heat losses to be minimised at certain temperatures under which tar can be thermodynamically cracked. The most favourable values of compression ratio, air/fuel mass ratio, Ca/B, S/B, temperatures of carbonator and calciner are 5.1, 15, 0.53, 0.17, 650° C. and 800° C., respectively. With the above inputs, the net power generation efficiency of BIGCC/MLTR process was found to reach 25%, which is higher than those of other parallel processes. In addition, TGA-FTIR experiments also confirmed that bio-tars formed during biomass gasification can be effectively cracked in the presence of CaO at higher temperatures.

The inventors also contemplate that the MLTR process lends itself to other gasification processes and is not limited to a biomass gasification process that includes a combined cycle. For example, the inventors believe that the MLTR process can be used with a biomass gasification process that has only a small-scale gas engine (an internal combustion engine) instead of a gas turbine combined cycle. In another example, the MLTR process may be applied to coal gasification plants.

It will be appreciated that while the above embodiments have described the invention in terms of using calcium based particles in a calcium looping process, the invention is not limited to this particular mineral. Rather, the mineral particles that can be used in the MLTR process include a metal or a metal oxide that is suitable for a carbonation and/or oxidation reaction, and may include a mineral carbonate. These general reactions are shown in FIG. 1, where the Me/MeCO₃ is transferred to the tar cracker unit 15 and Me/MeO is transferred back to the regenerator 20. In some embodiments, the mineral particles are selected from the group consisting of: PbO; CaO; MgO; Na; K; ZnO; MnO; CoO; Li₂O; Sr; Fe; CuO; Mg olivine (Mg₂SiO₄); Mg serpentine (Mg₃Si₂O₅(OH)₄); wollastonite (CaSiO₃); basalt; bauxite; magnetite (Fe₃O₄); brucite (Mg(OH)₂); forsterite (Mg₂SiO₄); harzburgite (CaMgSi₂O₆); orthopyroxene (CaMgSi₂O₆); dunite (Mg₂SiO₃ with impurities); ilmenite (FeTiO₃); dolomite (CaMg(CO₃)₂) and combinations or mixtures thereof. In other words, the minerals which can be used in the MLTR process include all metals/metal oxides having a carbonation reaction (i.e. carbonate formation) tendency. Examples of metals/metal oxides include PbO, CaO, MgO, Na, K, ZnO, MnO, CoO, Li₂O, Sr, Fe and CuO. This extends to any mineral which has carbonation/oxidation reaction tendency. Examples of carbonation minerals include Mg olivine (Mg₂SiO₄); Mg serpentine (Mg₃Si₂O₅(OH)₄); wollastonite (CaSiO₃); basalt; bauxite; magnetite (Fe₃O₄); brucite (Mg(OH)₂); forsterite (Mg₂SiO₄); harzburgite (CaMgSi₂O₆); orthopyroxene (CaMgSi₂O₆); dunite (Mg₂SiO₃ with impurities); ilmenite (FeTiO₃); dolomite (CaMg(CO₃)₂). Furthermore, all combinations/mixtures of mineral carbonates and metal oxides can also be used in the MLTR process.

There will be a slight variation in the reactions in the reactors, depending on the mineral oxide or metal oxide that is used. Examples of carbonator reactions include the following:

CₓH_{y}→xC+y/2H₂ (7)

CₓH_{y}+MOₙ→MOₙ₋₁+xCO+y/2H₂ (8)

CₓH_{y}+MOₙ→MOₙ₋₁+xCO+y/2H₂ (9)

MO+CO₂→MCO₃ (10)

CₓH_{y}+H₂O→xCO+y/2H₂ (11)

Examples of calciner reactions include the following:

MCO₃→MO+CO₂ (12)

2MOₙ₋₁+O₂→2MOₙ (13)

The mineral particles used as catalytic materials include both synthetic and natural minerals. In particular, dolomite, ilmenite and olivine are found to be more suitable due to their lower cost and superior performance.

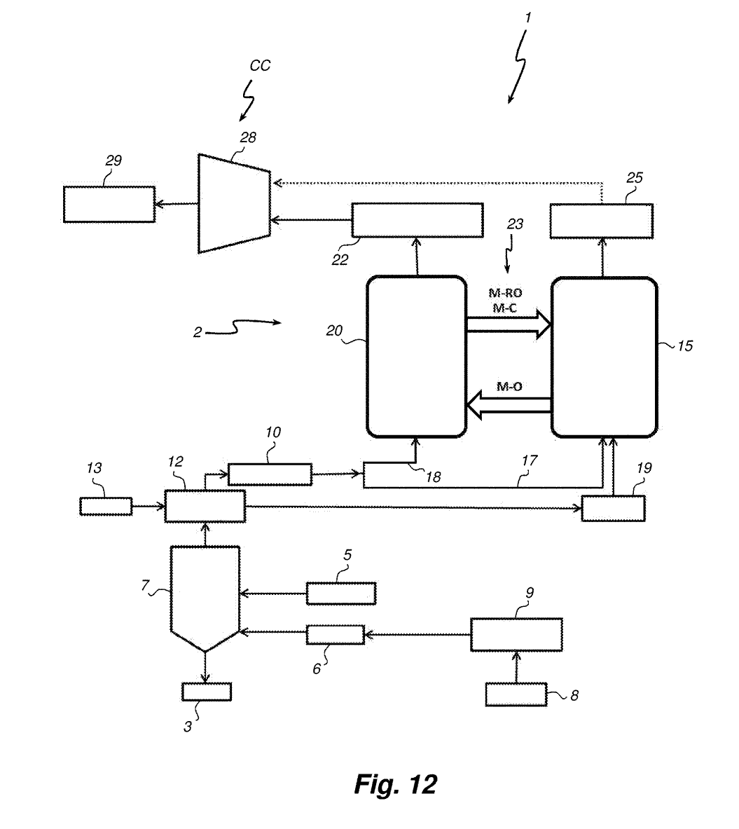

As shown in FIG. 12, the use of a mineral or metal oxide instead of a CaO and CaCO₃ does not significantly alter the process or system as an ex situ tar reformer via mineral looping. The basic principle is the same as shown in FIG. 1, where the mineral looping process 2 consists of two reactors, the tar cracker unit 20 and the regenerator 15, between which minerals are circulated in a looping fashion via the loop 23. The only difference between FIG. 1 and FIG. 12 is the identification of the mineral/metal oxides as M-O, which are fed into the tar cracker unit 20 along with bio-syngas 10 containing tar compounds from the gasification process in the gasifier 7. In the tar cracker unit 20, catalytic cracking of tars via mineral/metal oxides occurs via Equation (7), any metal oxides present in the tar cracker unit 20 will release oxygen and move to a lower oxidation state, this oxygen can then oxidise tar compounds to form syngas 10 and CO₂ via Equations (8) and (9). Simultaneous minerals with carbonation tendencies will capture CO₂ to form mineral carbonates via Equation (10).

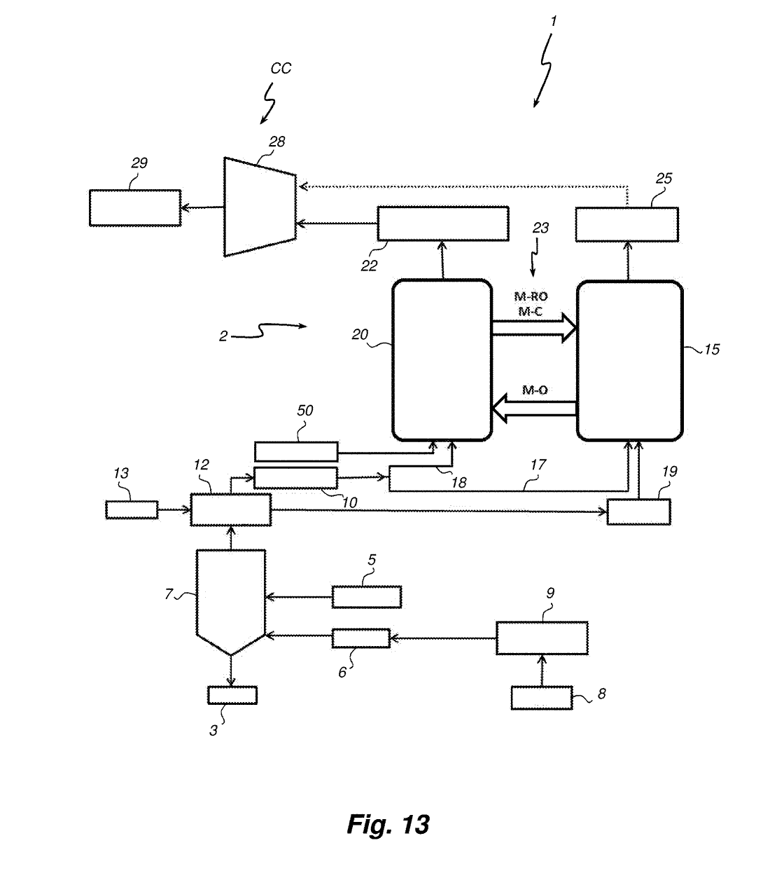

In the further embodiment of the invention illustrated in FIG. 13, steam 50 is introduced into the tar cracker unit 20 to cause a reforming reaction via Equation (11). All other features of the embodiment of FIG. 13 are the same as the features of FIG. 12. Once the mineral has undergone carbonation (M-C in FIGS. 12 and 13) or the metals oxides have been reduced to a lower oxidation state (M-RO in FIGS. 12 and 13), they are circulated to the regenerator 15, where the mineral carbonates release CO₂ as shown in Equation (12) to return to their original mineral oxide and the reduced metal oxides react with oxygen in the air to move back to a higher oxidation state as shown in Equation (13). The regenerated mineral/metal oxides are then looped back to the tar cracker unit 20 and the process repeated continually.

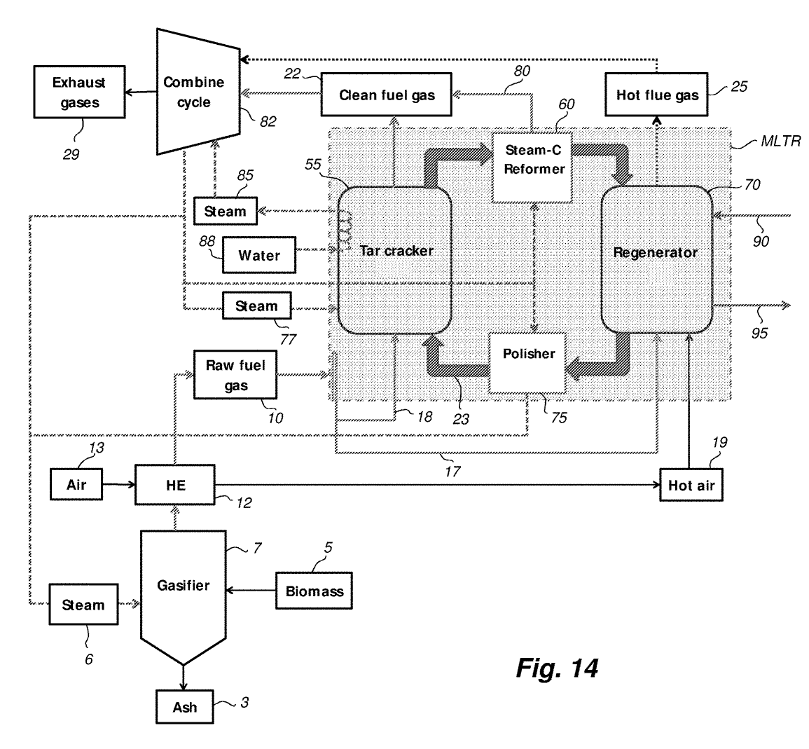

A further embodiment is illustrated in FIG. 14, where the method and system of FIGS. 1 and 12 have been modified to include additional steps (and associated apparatus) of carbon reforming and polishing between the carbonation, calcination, oxidation and/or reduction reactions in the reactors corresponding to the regenerator 15 and tar cracker unit 20 of FIGS. 1 and 12 connected in a mineral looping process MLTR, which is illustrated by the arrows 23 to indicate the loop. In this embodiment, the MLTR process involves multiple cyclic physico-chemical reactions (i.e. tar cracking, carbon reforming, carbonation, calcination, oxidation, reduction and polishing reactions in four different reactors—a tar cracker 55, a carbon reformer 60, a regenerator 70, and a polisher 75. Preferably, the embodiment of FIG. 14 uses a mixture of low cost minerals or waste materials as catalysts for tar removal and conversion. Examples include limestone, dolomite, olivine, ilmenite, construction demolition waste and any materials rich in calcium, magnesium and/or iron. The prime objective of this modified MLTR process is to convert the tars into a useful form of energy.

The raw fuel gas (syngas) 10 primarily enters the tar cracker unit 55, which preferably operates at temperatures in the range of 450° C. to 800° C. and at pressures of 1 to 100 bar. The tar cracker 55 performs catalytic cracking of the tar in the presence of the mineral/metal oxide particles or mixtures thereof. If a controlled amount of steam 77 is injected into the tar cracker unit 55, reforming reactions will also occur in the tar cracker unit 55. During tar cracking, several side reactions such as mineral carbonation (i.e. where the mineral oxide is lime or dolomite) and reduction (i.e. where the metal oxide is ilmenite or olivine) may occur based on the chemical-equilibrium conditions pertinent to the operating temperature of the tar cracker unit 55. Also, soot/carbon formation occurs on the surface of the minerals while any sulphur and chlorine present in the raw synthesis gas 10 is captured. The reactions that may occur in the tar cracker unit 55 are as follows:

Catalytic Tar Cracking: aCₙHₓ→bCₘH_{y}+dH₂

Catalytic Steam Reforming: CₙHₓ+nH₂O→(n+x/2)H₂+nCO

Catalytic Dry Reforming: CₙHₓ+nCO₂→(x/2)H₂+2nCO

Soot formation or carryover: CₙHₓ→nC+(x/2)H₂

Carbonation: MO+CO₂→MCO₃

MeO+CO₂→MeCO₃

Reduction: MeO→Me+½O₂

Sulfation: MO+H₂S→MS+H₂O

MeO+H₂S→MeS+H₂O

Chlorination: MO+2HCl→MCl₂+H₂O

MeO+2HCl→MeCl₂+H₂O

In the above reactions, CₙHₓ represents tar, CₘH_{y} represents hydrocarbons with smaller carbon number than CₙHₓ, M represents minerals and Me represents metal.

These side reactions (especially carbon formation on the surface of the mineral/metal mixture) may reduce the performance of the tar cracker unit 55 and therefore the mineral/metal mixture is continuously transported to the steam carbon (steam-C) reformer 60 where, in the presence of steam, carbon is converted to produce additional mole of H₂. The reaction that occurs in the steam-C reformer 60 is as follows:

Steam reforming of carbon: C+H₂O→CO+H₂

The operating temperature of the steam-C reformer 60 is in the range of 450° C. to 800° C. and the operating pressure of the steam-C reformer 60 is in the range of 1-100 bar.

The gaseous stream 80 produced in the steam-C reformer 60 is mixed with the clean fuel gas stream 22 generated from the tar cracker unit 55 and diverted to the combined cycle power plant 82 to generate heat and power. It will be appreciated that the combined cycle power plant 82 can be readily replaced with a gas engine, boiler-steam turbine or gas turbines to generate power.

After ensuring that carbon has been gasified to produce an additional mole of hydrogen (the gasification having occurred in the steam-C reformer 60 due to the presence of steam), the mineral/metal mixture is sent to a regenerator 70, where in the presence of hot air 19 and a portion of the raw fuel gas 10 diverted by conduit 17, the mineral/metal carbonates are decomposed to mineral/metal oxides. Also, reduced metal oxides are expected to be oxidised to their higher oxidation state. The operating temperature for regenerator 70 is between 750° C. and 1000° C. and the operating pressure is between 1 and 100 bar. The following reactions occur in the regenerator 70:

Calcination: MCO₃→MO+CO₂

MeCO₃→MeO+CO₂

Reduction: Me+½O₂→MeO

In the embodiment of FIG. 14, steam 85 is optionally generated by passing water 88 through the tar cracker 55 to exchange heat and conveying the generated steam 85 to the combined cycle plant 82. The exhaust gases 29 from the combined cycle plant 82 can also optionally be used to generate steam 6 for the gasifier 7, steam 77 for the tar cracker unit 55, steam for the steam-C reformer 60 and/or steam for the polisher unit 75.

Decomposition of sulphur and chlorine may be optional as this would require the flue gas cleaning step to be performed at the back end of the regenerator 70 before performing the heat recovery operation and/or exhausting the gases. Based on the fuel type and amount of sulphur and chlorine present in the original fuel, the extent of sulphur and chlorine decomposition can be controlled. For decomposition reactions in the regenerator 70, oxygen from air or steam can be used, although in this embodiment preheated hot air 19 is used. The decomposition reaction in the regenerator 70 is as follows:

De-sulfation: MS+O₂→M+SO₂

MeS+O₂→Me+SO₂

MS+H₂O→M+H₂S

MeS+H₂O→Me+H₂S

De-chlorination: MCl₂+H₂O→MO+2HCl

MeCl₂+H₂O→MeO+2HCl

Fresh mineral/metal mixture 90 can be added to the regenerator 70 to replenish spent mineral/metal mixture that has become saturated with sulphur and/or chlorine. The spent mineral mixture 95 (generally in the form of metal/mineral chlorides or metal/mineral sulphides) is purged off after several cycles from the system. The purging or makeup can be done from any location of the MLTR loop 23.

Finally, before sending the regenerated mineral/metal mixture back to the tar cracker 55, it passes through the polisher unit 75 where in the presence of steam, the pores of mineral/metal mixtures are reactivated with hydration reactions. The mineral/metal mixtures are deactivated due to the strong carbon/carbonate layer formation on the surface of mineral/metal mixture particles. This layer if not treated stays permanently and thus deactivates the pores which usually allow gases to diffuse through and enable the reactions to occur. As a pore activation process, the aim in the polisher unit 75 is to cause physical and chemical reactions between the deposits (carbon/carbonate) and water (in the steam) to liberate the carbon via reforming and consequently forming hydrates. The operating temperature of the polisher unit 75 is in the range of 750° C. to 1000° C. and the operating pressure of the polisher unit 75 is in the range of 1-100 bar. The polisher unit 75 ensures the longer term recyclability of the mineral/metal mixtures since it addresses the issues of catalyst deactivation due to carbon build up and poisonous gas adsorption on the catalyst surface, difficulty in regeneration, partial oxidation of fuel gas and carryover of fines that may occur in the use of mineral particles in catalytic removal of tar in the synthesis gas.

Experimental work has been performed on the embodiment of FIG. 14. It has been determined that a mineral mixture comprising 60% lime, 20% dolomite, 10% ilmenite and 10% olivine resulted in substantially the same results as shown in FIG. 10. That is, more than 95% of the tar conversion can be achieved with such a mineral mixture when used in a 1:1 ratio of mineral mixture to biomass. There was a reasonable amount of carbon deposited on the mineral surface after experiments but was completely reformed in the steam environment of the steam reformed 60 and the mineral mixture was regenerated completely in the air environment of the regenerator 70.

In some embodiments, the tar cracker unit 55 comprises the tar cracker unit 20 shown in FIG. 1. Likewise, in some embodiments, the regenerator 70 comprises the regenerator 15 shown in FIG. 1. In other embodiments, the tar cracker unit 55 and the regenerator 70 can each comprise a moving bed or fluidised bed reactor.

It will be appreciated that the above described embodiments of the invention, primary products from the tar cracker unit 20, 55 are hydrogen, carbon monoxide, carbon dioxide and water vapour and a mineral carbonate.

In some embodiments, the synthesis gas is produced from sources other than biomass, such as coal, crude oil or methane. In other embodiments, the biomass is selected from the group consisting of but is not limited to Paulownia, Beema Bamboo, Melia Dubia, Casuarina, Eucalyptus, Leucaena and Prosopis.

The advantages of the MLTR process are as follows:
(1) Unlike other conventional catalytic tar removal processes that involve multiple steps, tar removal and conversion efficiency is simpler, more efficient and improved greatly.
(2) The regeneration and recirculation of mineral/metal particles results in the raw material cost for catalytic tar removal being reduced significantly.
(3) In the MLTR process, based on the carbonation reaction intensity, the energy density of the treated fuel gas after tar removal will increase by at least 100-300 times (mainly due to the production a hydrogen enriched product stream along with the tar cracking and reforming reactions). Such a hydrogen enriched stream is expected to reduce the required size of the gas engine, turbine or steam boiler in the combined cycle plant 28, as well as increase thermal and electrical efficiency of the biomass gasification process.
(4) In situ removal of sulphur and chlorine from the fuel gas can be achieved in the MLTR process.
(5) The MLTR process can be retrofitted to any existing or new biomass gasification system for heat/power/biofuel generation.

It will further be appreciated that any of the features in the preferred embodiments of the invention can be combined together and are not necessarily applied in isolation from each other. For example, the steam-C reformer 60 and/or polisher unit 75 may be used in the embodiments of FIG. 1, 2, 12 or 13. Similar combinations of two or more features from the above described embodiments or embodiments of the invention can be readily made by one skilled in the art.

By providing mineral particles to catalyse tar from a synthesis gas and regenerating those mineral particles, the invention improves tar removal efficiency, reduces material consumption of the mineral particles and complexity in tar removal processes, increases the energy density of the synthesis gas and avoids ash separation. All these advantages of the invention result in improved efficiency in the gasification process, especially biomass gasification. Furthermore, the invention can be readily implemented to existing gasification systems, especially biomass gasification systems. In all these respects, the invention represents a practical and commercially significant improvement over the prior art.

Although the invention has been described with reference to specific examples, it will be appreciated by those skilled in the art that the invention may be embodied in many other forms.

1. A method for removing tar from a synthesis gas, comprising:
feeding the synthesis gas into a first reactor;
feeding mineral particles into the first reactor;
catalysing tar in the synthesis gas with the mineral particles to produce a mixture comprising hydrogen and a mineral carbonate;
feeding the mineral carbonate into a second reactor;
feeding oxygen into the second reactor to react with the mineral carbonate and produce a flue gas comprising carbon dioxide and mineral particles;
separating the carbon dioxide from the mineral particles; and
recycling the mineral particles to the first reactor.

2. The method of claim 1, further comprising reforming carbon from the mixture.

3. The method of claim 2, wherein the carbon is reformed in the presence of steam.

4. The method of claim 3, wherein the carbon reforming step comprises directing the mixture to a first chamber and feeding steam into the first chamber.

5. The method of claim 4, wherein the temperature of the steam in the first chamber is between 450° C. and 800° C.

6. The method of claim 4 or 5, wherein the pressure of the steam in the first chamber is between 1 bar and 100 bar.

7. The method of any one of the preceding claims, further comprising passing the mineral particles through a gas to reactivate the mineral particles.

8. The method of claim 7, wherein the gas comprises steam.

9. The method of claim 7 or 8, wherein the reactivating step comprises directing the mixture to a second chamber and feeding steam into the second chamber.

10. The method of claim 9, wherein the temperature of the steam in the second chamber is between 750° C. and 1,000° C.

11. The method of claim 9 or 10, wherein the pressure of the steam in the second chamber is between 1 bar and 100 bar.

12. The method of any one of claims 7 to 12, wherein the reactivating step is performed before recycling the mineral particles to the first reactor.

13. The method of any one of the preceding claims, further comprising feeding a portion of the synthesis gas to a combustion unit for generating power to operate the second reactor.

14. The method of claim 13, further comprises feeding the remaining synthesis gas into the first reactor.

15. The method of any one of the preceding claims, further comprising connecting the first reactor to the second reactor to form a mineral-looping process.

16. The method of any one of the preceding claims, wherein the mineral particles are depleted in the first reactor and regenerated in the second reactor.

17. The method of claim 16, wherein the mineral particles are reduced in the first reactor and oxidised in the second reactor.

18. The method of claim 16 or 17, wherein the mineral particles are carbonated in the first reactor to form a mineral carbonate and the mineral carbonate is decomposed into the mineral particles in the second reactor.

19. The method of any one of claims 16 to 18, wherein the first reactor is a tar cracker unit and the second reactor is a regenerator.

20. The method of any one of the preceding claims, further comprising gasifying a biomass to produce the synthesis gas.

21. A system for removing tar from a synthesis gas, comprising:
a first reactor for receiving the synthesis gas;
a first conduit for feeding a mineral particles into the first reactor to catalyse tar in the synthesis gas and produce a mixture comprising hydrogen and a mineral carbonate;
a second reactor for receiving oxygen, wherein the first and second reactors are connected to form a chemical looping process so that the mineral carbonate is transferred to the second reactor; and
a second conduit for feeding the oxygen into the second reactor to react with the mineral carbonate and produce a flue gas comprising carbon dioxide and mineral particles;
wherein the mineral particles from the second reactor is recycled to the first reactor.

22. The system of claim 21, further comprising a first chamber for reforming carbon from the mixture.

23. The system of claim 22, wherein the first chamber has a inlet for receiving steam to reform the carbon from the mixture.

24. The system of claim 23, the first chamber comprises a steam reformer unit.

25. The system of any one of claims 21 to 24, further comprising a second chamber for reactivating the mineral particles.

26. The system of claim 25, wherein the second chamber has an inlet for receiving steam to reactivate the mineral particles.

27. The system of claim 26, wherein the second chamber comprises a polisher unit.

28. The system of any one of claims 21 to 27, further comprising a third conduit for feeding a portion of the synthesis gas to a combustion unit for generating power to operate the second reactor.

29. The system of claim 28, further comprising a fourth conduit for feeding the remaining synthesis gas into the first reactor.

30. The system of any one of claims 21 to 29, wherein the first reactor and the second reactor are connected to form a mineral-looping process.

31. The system of any one of claims 21 to 30, wherein the mineral particles are depleted in the first reactor and regenerated in the second reactor.

32. The system of claim 31, wherein the mineral particles are reduced in the first reactor and oxidised in the second reactor.

33. The system of claim 31 or 36, wherein the mineral particles are carbonated in the first reactor to form a mineral carbonate and the mineral carbonate is decomposed into the mineral particles in the second reactor.

34. The method of any one of claims 31 to 33, wherein the first reactor is a tar cracker unit and the second reactor is a regenerator.

35. The system of any one of claims 21 to 34, wherein the first reactor has an outlet for removing the hydrogen from separated from the mineral carbonate in the mixture.

36. The system of any one of claims 21 to 35, wherein the second reactor has an outlet for removing the hydrogen from separated from the mineral carbonate in the mixture.

37. The system of any one of claims 21 to 36, further comprising a gasifier for gasifying a biomass to produce the synthesis gas.
